(19) United States
(12) Patent Application Publication
(10) Pub. No.: US 2006/0044982 A1
(43) Pub. Date: Mar. 2, 2006

(54) Disc tray with stepped structure and disc drive having the same

(75) Inventors: Bin-Hai Guo, Shenzhen (CN); Chien-Ting Lo, Tu-Cheng (TW); Li-Ming Wan, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/203,364

(22) Filed: Aug. 12, 2005

(30) Foreign Application Priority Data
Aug. 13, 2004 (CN) 200420083048.5

(51) Int. Cl. G11B 33/02

(52) U.S. Cl. 369/77.21

(57) ABSTRACT

A disc tray for receiving a disc having a rim non-recording portion is provided. The disc tray includes a first receiving portion and a first stepped structure. The first receiving portion is adapted for receiving the disc. The first stepped structure is arranged at a periphery of the receiving portion. Said first stepped structure includes an upper step and a neighboring lower step. The lower step is adapted for supporting the rim non-recording portion of the disc. Each of the upper and lower steps has a radial width less than a radial width of the disc. A related disc drive having said disc tray is also provided.

### BACKGROUND

1. Field of the Invention

The present invention is related to disc drives, and particularly to a disc tray for use in a disc drive.

2. General Background

Optical discs such as compact discs, digital video discs, laser discs, and other similar recording media have been widely used in recent years. Referring to FIG. 1, an optical disc 3 is generally circular, and comprises, from a center to a periphery thereof, a center hole 1a, a motor-mounting portion 2a, an annular data-recording portion 3a, and a rim portion 4a. The center hole 1a is defined in the motor-mounting portion 2a. The motor-mounting portion 2a is for contacting a spindle motor of a disc reader/writer, whereby the spindle motor can rotate the disc mounted thereon. The motor-mounting portion 2a is not for recording data. The annular data-recording portion 3a is located adjacent the motor-mounting portion 2a, and is for recording data such as video data, audio data, or other information. The rim portion 4a is provided for resting on a step of a disc tray of the disc reader/writer, and thereby preventing the data-recording portion 3a from being scratched when the disc 3 is accommodated in the disc tray. The rim portion 4a is not for recording any data either.

A traditional optical disc drive, such as a disc recording and/or reproducing device, includes a disc tray. The disc tray includes a body, the body having a disc accommodating area formed on a top surface thereof. An annular sidewall extends down from the top surface of the body. A step is formed at a periphery of the disc accommodating area. The step is provided for supporting the rim portion 4a, whereby the data-recording portion 3a is elevated slightly above a bottom surface of the disc accommodating area. Thus the data-recording portion 3a avoids damage that could otherwise occur due to direct contact with the bottom surface of the disc accommodating area.

Commonly, a radius r of the disc 3 is less than that of the disc accommodating area. A radial width of the step is generally greater than that of the rim portion 4a (r1). For example, when a disc tray is oriented vertically for a vertically oriented disc drive, a plurality of holding claws is provided above the step in order to prevent a disc from falling off. However, because the radial width of the step is generally greater than a radial width r1 of the rim portion 4a, the disc 3 is liable to be offset from its regular position during loading. A peripheral edge of the data-recording portion 3a is thus liable to come into contact with the step and be scratched.

In view of this disadvantage, another kind of disc tray has been developed. The disc tray includes a disc receiving area having a protective layer formed of polyurethane resin. A thickness of said protective layer is approximately 20 to 50 μm. The protective layer serves as a buffer to prevent a disc accommodated therein from being damaged. However, forming the protective layer is time-consuming, and manufacturing costs are increased.

Therefore, a heretofore unaddressed need exists in the industry to address the aforementioned deficiencies and inadequacies.

### SUMMARY

A disc tray for receiving a disc having a rim non-recording portion is provided. The disc tray includes a first receiving portion and a first stepped structure. The first receiving portion is adapted for receiving the disc. The first stepped structure is arranged at a periphery of the receiving portion. Said first stepped structure includes an upper step and a neighboring lower step. The lower step is adapted for supporting the rim non-recording portion of the disc. Each of the upper and lower steps has a radial width less than a radial width of the disc.

A disc drive includes a disc tray for receiving a disc having a rim non-recording portion. The disc tray includes a first receiving portion and a first stepped structure. The first receiving portion is adapted for receiving the disc. The first stepped structure is arranged at a periphery of the receiving portion. Said first stepped structure includes an upper step and a neighboring lower step. The lower step is adapted for supporting the rim non-recording portion of the disc. Each of the upper and lower steps has a radial width less than a radial width of the disc.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of a typical disc.

FIG. 2 is an isometric view of a disc drive in accordance with an exemplary embodiment of the present invention, with a disc tray thereof being ejected out.

FIG. 3 is an enlarged view of a circled portion III of FIG. 2.

FIG. 4 is an isometric view of the disc tray of FIG. 2, with the disc received therein.

FIG. 5 is a cross-sectional view taken along line V-V of FIG. 4, showing the disc placed at an appropriate position.

FIG. 6 is a cross-sectional view of the disc tray with the disc taken along line V-V of FIG. 4, showing the disc offset from the appropriate position.

### DETAILED DESCRIPTION OF THE PREFERRED EMBODIMENTS

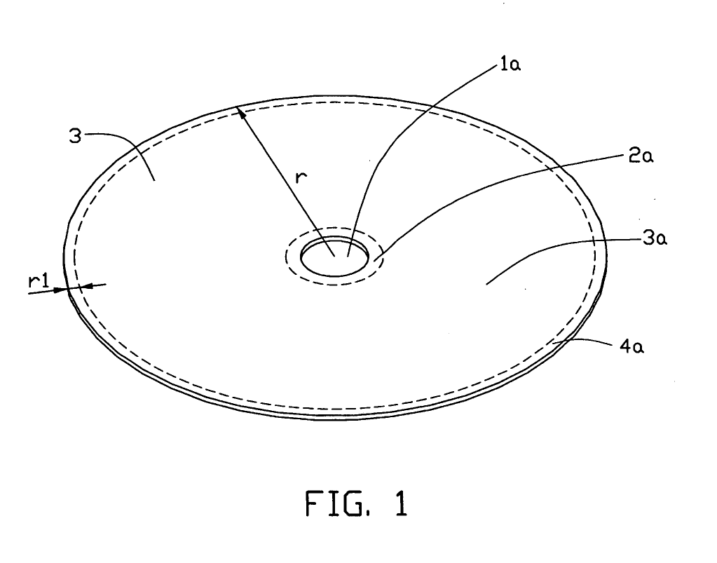

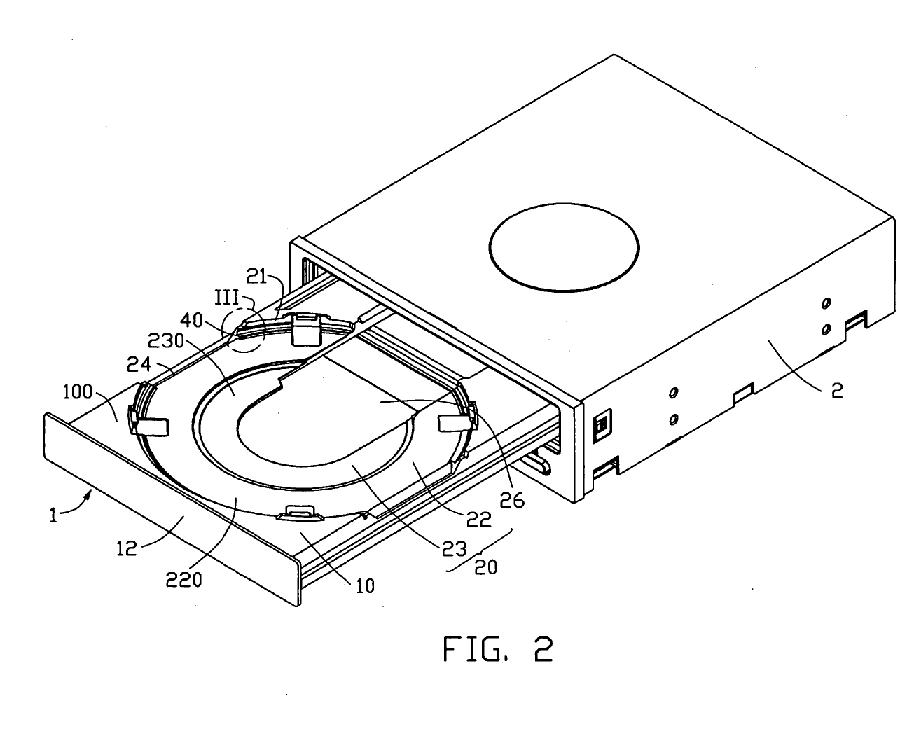

Referring to FIGS. 1 and 2, a disc tray 1 is mounted in an outer enclosure of a disc drive 2 for loading/unloading a disc 3. The disc tray 1 includes a main body 10 having a top surface 100, and a stop plate 12 perpendicular to the top surface 100. A recessed disc accommodating area 20 is formed on the main body 10. A sidewall 21 extends down from the top surface 100. The recessed disc accommodating area 20 includes a first receiving portion 22 and a concentric second receiving portion 23. The first receiving portion 22 is depressed from the top surface 100 of the main body 10. The second receiving portion 23 is concentrically depressed from a first bottom surface 220 of the first receiving portion 22. The first receiving portion 22 is provided for receiving the disc 3 having a diameter of 12 cm, while the second receiving portion 23 is provided for receiving a disc having a diameter of 8 cm. The first receiving portion 22 includes the first bottom surface 220. The second receiving portion 23 includes a second bottom surface 230. Two opposite openings 24 are defined at two opposite sides of the first receiving portion 22 whereby the sidewall 21 is divided into four arcs. An opening 26 is defined in the disc accommodating area 20. The opening 26 is provided for loading data information from the disc 3 by a pickup head (not shown). A stepped structure 40 is formed adjacent the sidewall 21. The stepped structure 40 is provided for supporting the rim portion 4a of the disc 3.

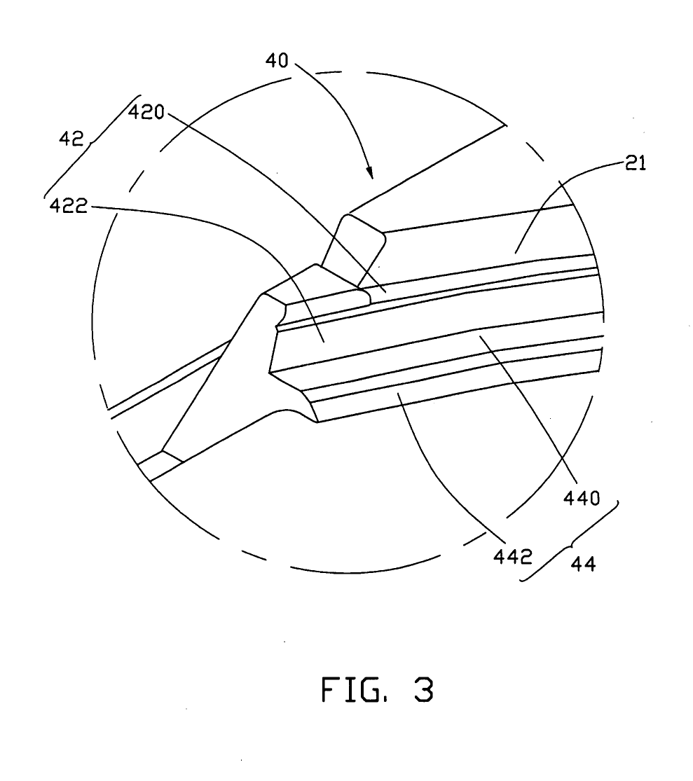

Referring to FIG. 3, the stepped structure 40 is integrally formed with the main body 10. The stepped structure 40 includes a first step 42 and a second step 44. The first step 42 includes a first tread surface 420, and a first side surface 422 extending down from the first tread surface 420. The second step 44 includes a second tread surface 440, and a second side surface 442 extending down from the second tread surface 440. The first tread surface 420 and the second tread surface 440 are substantially parallel to the first bottom surface 220 of the first receiving portion 22 and the second bottom surface 230 of the second receiving portion 23. In order to reduce the risk of misplacing of the disc 3 leaning against the first step 42, the first step surface 420 is preferably configured to be slightly higher than the second tread surface 440. The second tread surface 440 is slightly higher than the first bottom surface 220.

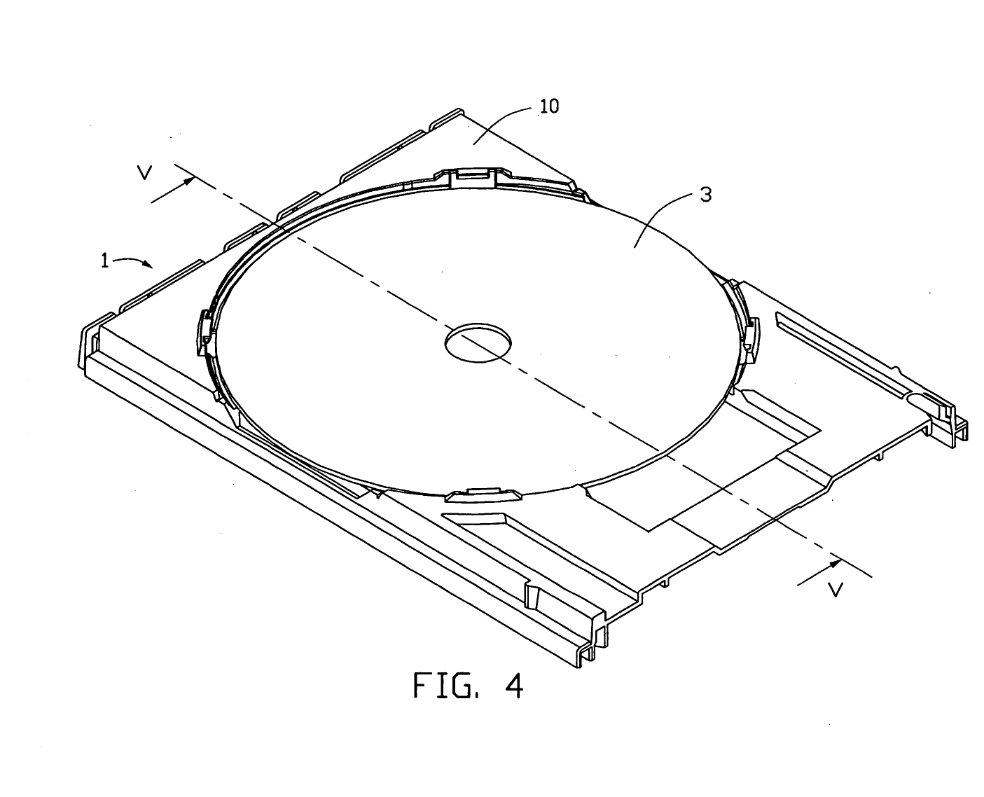

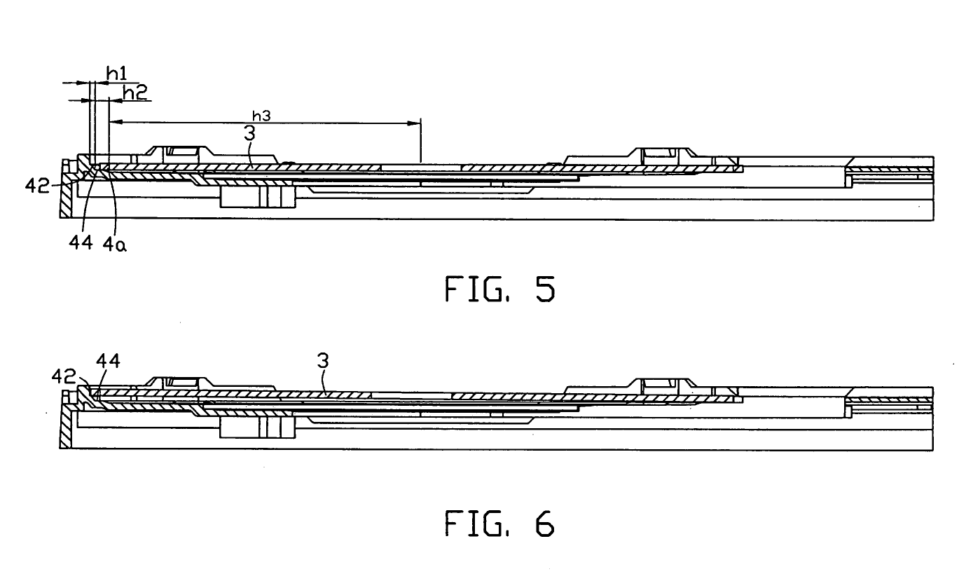

FIG. 4 and FIG. 5 show the disc tray 1 with the disc 3 accommodated therein. The disc 3 is placed at an appropriate position, with the rim portion 4a thereof resting on the second step 42. Both a radial width h1 of the first tread surface 420 and a radial width h2 of the second tread surface 440 are slightly less than a radial width r1 of the rim portion 4a. The radial width h2 of the second tread surface 440, plus a radius h3 of the first bottom surface 220 of the first receiving portion 22, is greater than a radius r of the disc 3. That is, h2+h3>r.

When the disc 3 is placed at the appropriate position in the first receiving portion 22, the rim portion 4a is supported by the second tread surface 440 of the step 44, and the data-recording portion 3a is slightly elevated above the first bottom surface 220 of the first receiving portion 22. Therefore the data-recording portion 3a does not contact the first bottom surface 220 of the first receiving portion 22, and thus avoids scratching. Since the radial width h2 of the second tread surface 440 is smaller than the radial width r1 of the rim portion 4a, the risk of direct contact between the data-recording portion 3a of the disc 3 and the second tread surface 440 is reduced. Therefore, the data-recording portion 3a of the disc avoids damage during the process of the disc 3 being loaded.

Referring to FIG. 6, this is a cross-sectional view of the disc tray 1 with the disc 3 accommodated therein, when the disc 3 is accidentally displaced away from the appropriate position. In this case, one part of the rim portion 4a of the disc 3 leans against the first tread surface 420 of the first step 42, and the other opposite part of the rim portion 4a thus rests on the second tread surface 440. Therefore, scratching of the data-recording portion 3a can be avoided.

In addition, when the tray 1 is vertically oriented, the disc 3 is liable to be offset from the appropriate position due to gravitational force acting on the disc. In this case, one part of the rim portion 4a of the disc 3 is held by holding claws (not labeled), and the other opposite part of the rim portion 4a of the disc 3 rests on the second tread surface 440. Therefore scratching of the data-recording portion 3a can also be avoided.

In another exemplary embodiment, the first tread surface 420 and the second tread surface 440 are not parallel, but are slightly inclined toward the first bottom surface 220 and the second bottom surface 230, in order to reduce contact areas between the first tread surface 420 or the second tread surface 440 and the rim portion 4a of the disc 3.

It should be noted that the number of steps of the stepped structure 40 is not limited to the above-described exemplary embodiments. In addition, the stepped structure 40 can alternatively be a plurality of protrusions with identical heights extending from the sidewall 21.

Furthermore, a stepped structure that is similar to the stepped structure 40 can be provided around the second bottom surface 230, for supporting a rim portion of a disc having a diameter of 8 cm.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description but rather by the spirit and scope of the claims that follow, and their equivalents.

What is claimed is:

1. A disc tray for receiving a disc having a non-recording portion, the disc tray comprising:
a first receiving portion adapted for receiving the disc; and
a first stepped structure arranged at a periphery of the receiving portion, said first stepped structure comprising an upper step and a neighboring lower step, the lower step being adapted for supporting the non-recording portion of the disc, each of the upper and lower steps having a radial width less than a radial width of the non-recording portion of the disc.

2. The disc tray as claimed in claim 1, wherein a sum of a radial width of the lower step and a radius of the first receiving portion is greater than a radius of the disc.

3. The disc tray as claimed in claim 1, wherein the first receiving portion is provided for receiving a disc with a first diameter of approximately 12 cm.

4. The disc tray as claimed in claim 0, further comprising a second receiving portion depressed concentrically from the first receiving portion, the second receiving portion being adapted for receiving a disc with a second diameter of approximately 8 cm.

5. The disc tray as claimed in claim 4, further comprising a second stepped structure adjacent the second receiving portion, said second stepped structure comprising an upper step and a neighboring lower step, the lower step being adapted for supporting the rim non-recording portion of the disc of the second diameter, each of the upper and lower steps of said second stepped structure having a radial width less than a radial width of a rim portion of the disc of the second diameter.

6. A disc drive, comprising:
a disc tray for receiving a disc having a non-recording portion therein, comprising:
a first receiving portion adapted for receiving the disc; and
a first stepped structure arranged at a periphery of the first receiving portion, said first stepped structure comprising an upper step and a neighboring lower step, the lower step being adapted for supporting the non-recording portion of the disc, each of the upper and lower steps having a radial width less than a radial width of the non-recording portion of the disc.

7. The disc drive as claimed in claim 6, wherein a sum of a radial width of the lower step and a radius of the first receiving portion is greater than a radius of the disc.

8. The disc drive as claimed in claim 6, wherein the first receiving portion is provided for receiving a disc with a first diameter of approximately 12 cm.

9. The disc drive as claimed in claim 8, further comprising a second receiving portion depressed concentrically from the first receiving portion, the second receiving portion being adapted for receiving a disc with a second diameter of approximately 8 cm.

10. The disc drive as claimed in claim 8, further comprising a second stepped structure adjacent the second receiving portion, said second stepped structure comprising an upper step and a neighboring lower step, the lower step being adapted for supporting the non-recording portion of the disc of the second diameter, each of the upper and lower steps of said second stepped structure having a radial width less than a radial width of a non-recording portion of the disc of the second diameter.

11. A disc drive comprising:
an outer enclosure of said disc drive; and
a tray movably installed in said outer enclosure and defining a receiving portion adapted for receiving a disc compatible to said disc drive therein, a stepped structure defined at a periphery of said receiving portion, and said stepped structure comprising at least two steps so that a non-recording portion of said disc is capable of abutting against a selective one of said at least two steps to support a recording portion of said disc away from any of said at least two steps.

12. The disc drive as claimed in claim 11, wherein said at least two steps of said stepped structure are disposed next to one another.

13. The disc drive as claimed in claim 11, wherein said at least two steps of said stepped structure are offset from one another along an orthogonal direction to a bottom surface of said receiving portion.

14. The disc drive as claimed in claim 11, wherein said at least two steps of said stepped structure tilt toward a center of said receiving portion.

15. The disc drive as claimed in claim 11, wherein a radial width of each of said at least two steps of said stepped structure relative to a center of said receiving portion is less than a radial width of said non-recording portion of said disc.
